(19) United States
(12) Patent Application Publication
(10) Pub. No.: US 2012/0113461 A1
(43) Pub. Date: May 10, 2012

(54) IMAGE PROCESSING APPARATUS FOR PROCESSING DOCUMENT DATA AND CONTROL METHOD THEREFOR

(75) Inventor: Taro TSUCHIDA, Kawasaki-shi (JP)

(73) Assignee: CANON KABUSHIKI KAISHA, Tokyo (JP)

(21) Appl. No.: 13/278,629

(22) Filed: Oct. 21, 2011

(30) Foreign Application Priority Data
Nov. 5, 2010 (JP) 2010-248641

(51) Int. Cl. G06K 15/02

(52) U.S. Cl. 358/1.15

(57) ABSTRACT

An image processing apparatus capable of efficiently acquiring pieces of information about document formats used in document services. When an instruction to access a document service is input by a user, the image processing apparatus acquires from the document service a document list for the document service and displays the list on a user interface. When a document is selected by the user from the list, the image processing apparatus acquires document data from the document service and outputs the document data. If the acquired document data cannot directly be output, a format of the document data is converted into a format compatible to the image processing apparatus according to a conversion path. The conversion path is updated, if information about format conversion acquired from the document service differs from that held in the image processing apparatus.

### BACKGROUND OF THE INVENTION

1. Technical Field

The present invention relates to an image processing apparatus and a control method therefor for processing document data by using document services provided on a network.

2. Description of the Related Art

In recent years, there have appeared document services for handling various document data on the Internet. With such document services, documents can be created and edited on the document services from a personal computer (PC) through a web browser, and document data can be downloaded and uploaded by the PC.

Some image processing apparatuses (such as copiers, printers, and digital multi-function peripherals) can be connected through office networks or home networks to external networks such as the Internet, and have a web browsing function, e-mail receiving function, etc.

However, a problem is sometimes caused in printing document data acquired by such an image processing apparatus using a document service since document data are provided in various formats.

Specifically, although image processing apparatuses are generally made compatible to plural document formats, it is not easy for the apparatuses to support all of various document formats. In particular, with technical progress in the Internet field, document formats used in document services are frequently updated, which makes it difficult for the apparatuses to immediately cope with update of document formats.

In this regard, document data conversion techniques have been proposed that enable an image processing apparatus to become cope with update of document formats. For example, a document management system has been proposed that converts an image format of an image document, as needed, to efficiently store image documents into a database (see, for example, Japanese Laid-open Patent Publication No. 2003-316772). Also, an image processing apparatus has been proposed, in which document elements of a document are converted into a requested representation form and the resultant document is transmitted to a network-connected client in response to an acquisition request from the client (see, for example, Japanese Laid-open Patent Publication No. 2004-357274).

However, with the techniques disclosed in Japanese Laid-open Patent Publications Nos. 2003-316772 and 2004-357274, data conversion processing must be made by an apparatus on the document data provision side or on the document data reception side, so that a large load is applied on the apparatus. Since there are day-to-day changes (such as addition of new functions) in document services on networks, it is preferable but difficult to always efficiently acquire new information.

In addition, due to a limitation in improving a user interface function of an image processing apparatus and due to frequent changes of document format information, satisfactory user-friendliness of the user interface cannot always be attained.

### SUMMARY OF THE INVENTION

The present invention provides an image processing apparatus and a control method therefor which are capable of efficiently acquiring pieces of information about document formats used in document services. The present invention also provides an image processing apparatus and a control method therefor which are capable of performing document data processing, without applying a large load on the document service provision side and on the image processing apparatus.

According to one aspect of this invention, there is provided an image processing apparatus capable of accessing plural document services through a network, which comprises a storage unit configured to store pieces of information about document format conversions executable by respective ones of the plural document services, a format acquisition unit configured, when a document service usable by a user among the plural document services is accessed, to acquire information about document format conversion from the accessed document service, an update unit configured to update the pieces of information about document format conversions stored in the storage unit based on the information about document format conversion acquired by the format acquisition unit, a data acquisition unit configured to acquire document data held in the accessed document service from the accessed document service, an output unit configured to output the document data acquired by the data acquisition unit, and a control unit configured to control the format acquisition unit and the data acquisition unit such that the format acquisition unit acquires the information about document format conversion after the data acquisition unit has acquired the document data.

With this invention, pieces of information about document formats can efficiently be acquired, and document data processing can be performed, without applying a large load on the document service provision side and on the image processing apparatus.

Further features of the present invention will become apparent from the following description of an exemplary embodiment with reference to the attached drawings.

### BRIEF DESCRIPTION OF THE DRAWINGS

FIG. 1 is a block diagram schematically showing the construction of an image processing apparatus according to one embodiment of this invention;

FIG. 2 is a view schematically showing an example form of connection between the image processing apparatus and document services;

FIG. 3A is a view schematically showing data stored in a RAM of the image processing apparatus;

FIG. 3B is a view schematically showing programs stored in a ROM of the image processing apparatus;

FIG. 4 is a view schematically showing a part of the contents of a document list held in one of the document services;

FIG. 5 is a view schematically showing a part of the contents of individual user's document service information stored in the RAM of the image processing apparatus;

FIG. 6 is a view schematically showing the contents of a document service list stored in the RAM;

FIG. 7 is a view schematically showing a part of the contents of a conversion path list stored in the RAM;

FIG. 8A is a view schematically showing a conversion rule defined in the conversion path list;

FIG. 8B is a view schematically showing conversion rules defined in the conversion path list;

FIG. 9A is a sequence diagram showing information exchange performed between the image processing apparatus and any of the document services;

FIG. 9B is a sequence diagram showing information exchange performed between the image processing apparatus and any of the document services which is utilized for the first time by a user;

FIG. 10 is a flowchart showing procedures of a process performed by the image processing apparatus in the information exchange sequences of FIGS. 9A and 9B;

FIG. 11 is a flowchart showing procedures of a document list creation process executed in step S105 of FIG. 10;

FIG. 12 is a flowchart showing procedures of a document list display process executed in step S106 of FIG. 10;

FIG. 13 is a flowchart showing procedures of an output process executed in step S107 of FIG. 10;

FIG. 14 is a flowchart showing procedures of a format conversion process executed in step S403 of FIG. 13;

FIG. 15 is a flowchart showing procedures of a conversion path update process executed in step S109 of FIG. 10;

FIG. 16 is a flowchart showing procedures of a conversion path search process executed in step S608 of FIG. 15;

FIG. 17 is a flowchart showing a whole output process executed by the image processing apparatus and comprised of process procedures, which are different from the process procedures shown in FIG. 10; and

FIG. 18 is a sequence diagram showing conventional information exchange executed between a document service and an image processing apparatus.

### DESCRIPTION OF THE EMBODIMENTS

The present invention will now be described in detail below with reference to the drawings showing a preferred embodiment thereof.

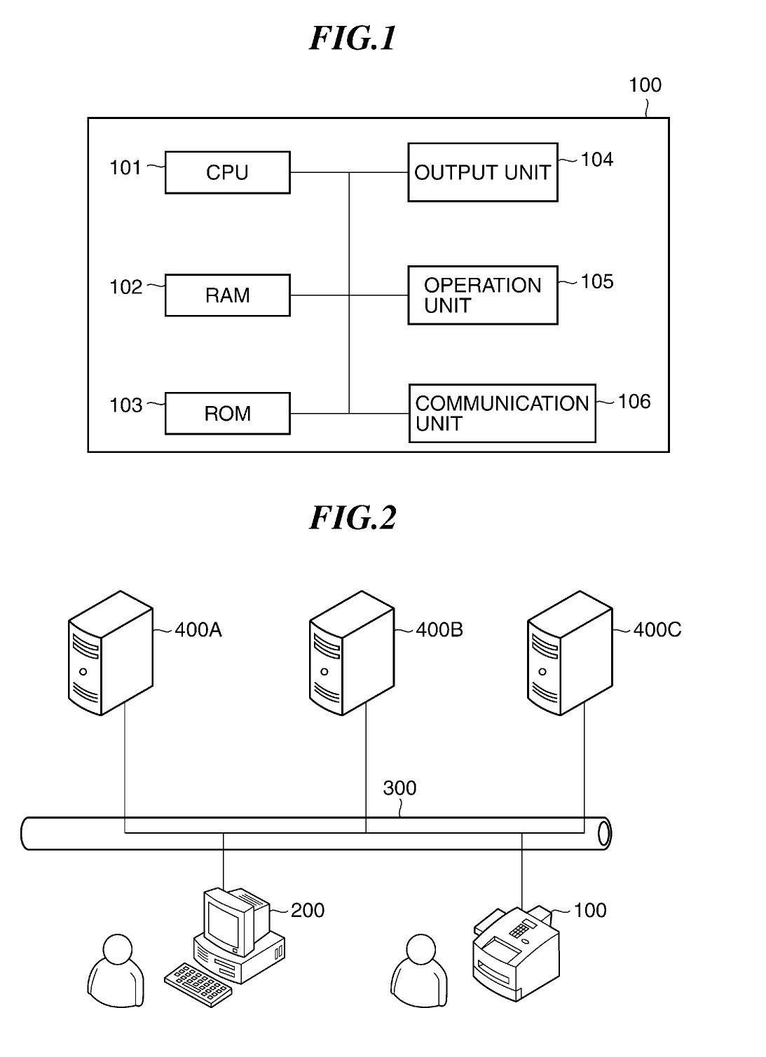

FIG. 1 schematically shows in block diagram the construction of an image processing apparatus according to one embodiment of this invention, and FIG. 2 schematically shows an example form of connection between the image processing apparatus and document services.

The image processing apparatus shown by reference numeral 100 in FIGS. 1 and 2 is embodied as a copier, printer, digital multi-function peripheral (MFP) or the like, and includes a CPU 101, RAM 102, ROM 103, output unit 104, operation unit 105, and communication unit 106.

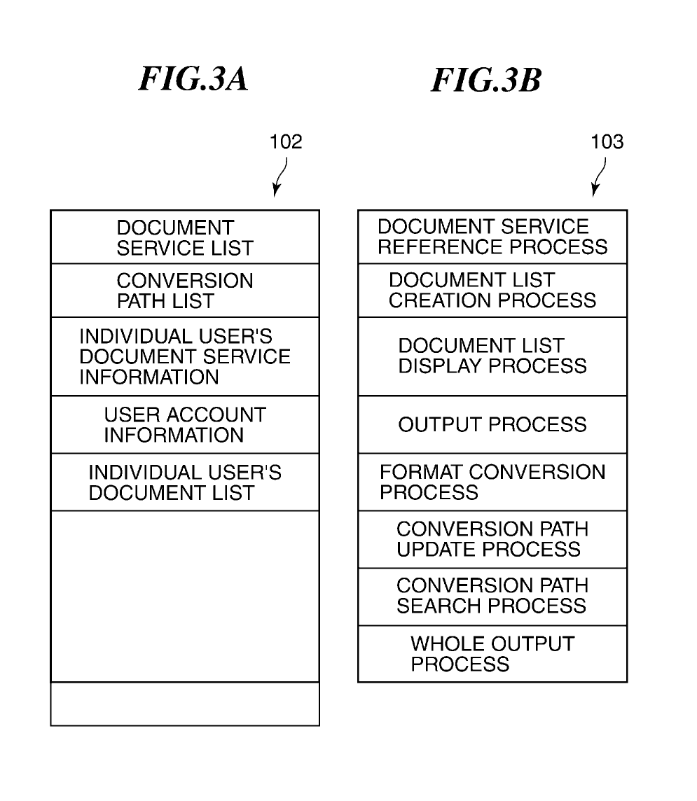

The CPU 101 controls the entire image processing apparatus 100. The RAM 102 has a work area for use by the CPU 101 to develop a program to be executed, a nonvolatile storage area that stores various data described later with reference to FIGS. 3A and 3B, and a temporary storage area that temporarily stores document data (such as document data and image data). The ROM 103 stores control programs executed by the CPU 101 and parameters.

The output unit 104 includes a storage section that stores document data and a printing section that prints document data read from the storage section. The operation unit 105 has a user interface that is operable by a user to give an instruction to start printing and that displays a state of the image processing apparatus 100 and an error occurred in the image processing apparatus 100. The communication unit 106 transmits and receives data to and from external apparatuses through a network 300 (FIG. 2).

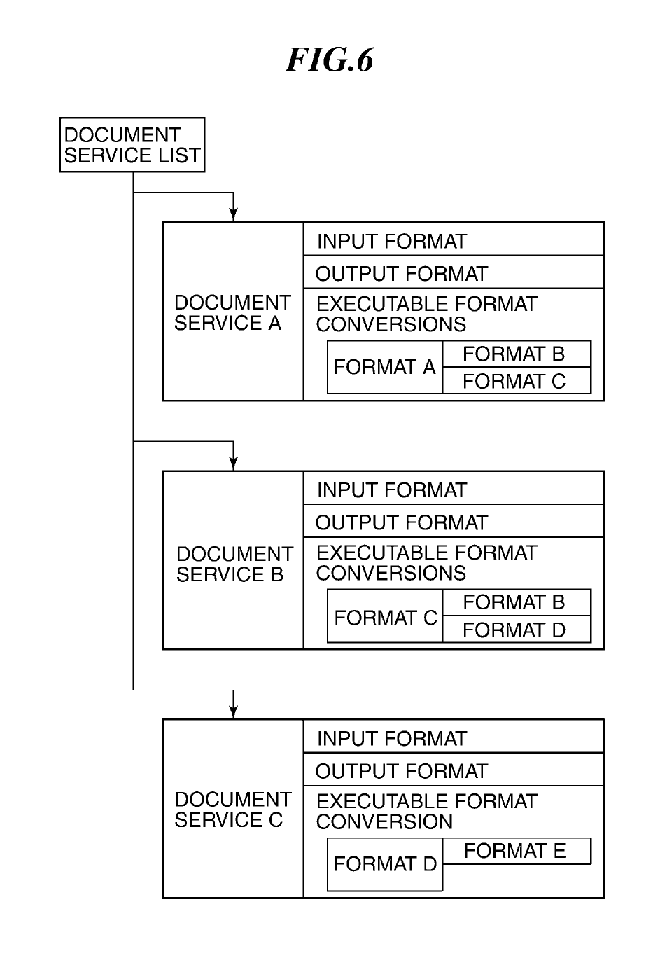

In the example shown in FIG. 2, the external apparatuses (i.e., a PC 200 and document service servers 400A, 400B and 400C) are connected to the image processing apparatus 100 through the network 300, and the document service servers 400A, 400B and 400C respectively provide three different document services A, B, and C (see FIG. 6). It should be noted that the number of document services that can be used by the image processing apparatus 100 is not limited to three, and the number of document service servers is not limited to three.

FIGS. 3A and 3B schematically show data stored in the RAM 102 and programs stored in the ROM 103 of the image processing apparatus 100.

In the RAM 102, there are stored various data shown in FIG. 3A. A document service list is a list of pieces of information about document formats that can be used in document services. A conversion path list is a list of pieces of information according to which document formats are converted into document formats usable in plural document services and in the image processing apparatus 100. Individual user's document service information is pieces of information that indicate document services to which individual users have subscribed or contracted. User account information is pieces of account information (such as user accounts or passwords) about documents services to which users subscribe. An individual user's document list is a list of documents collected on a per user basis and held in the image processing apparatus 100. It should be noted that the work area and the temporary storage area of the RAM 102 are shown as empty areas in FIG. 3A.

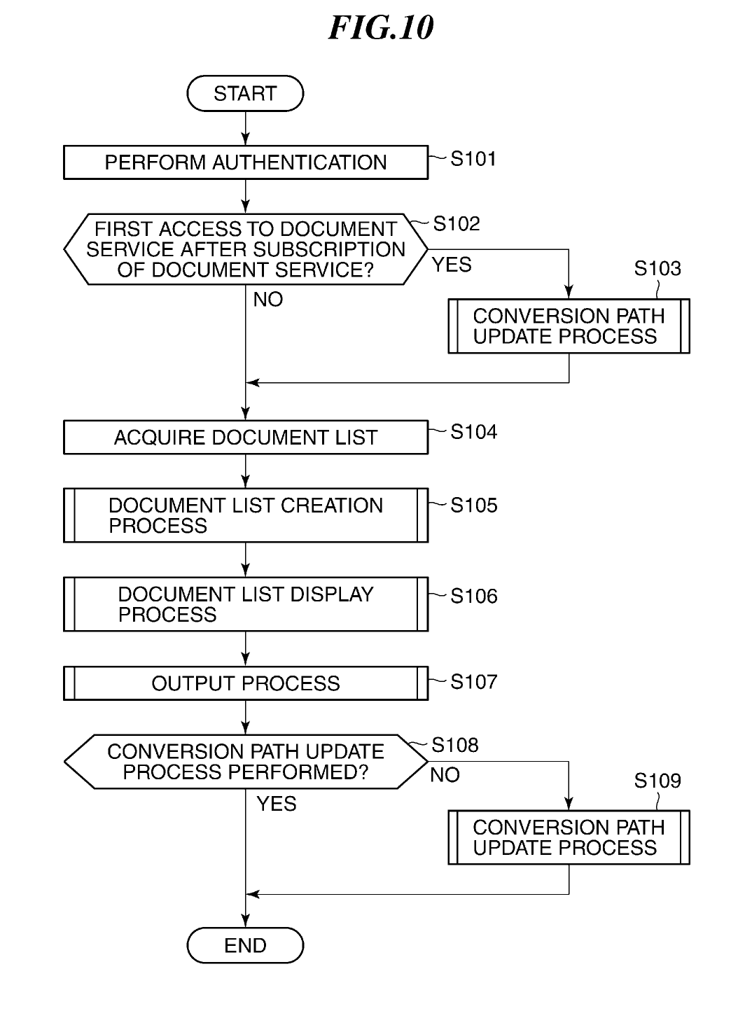

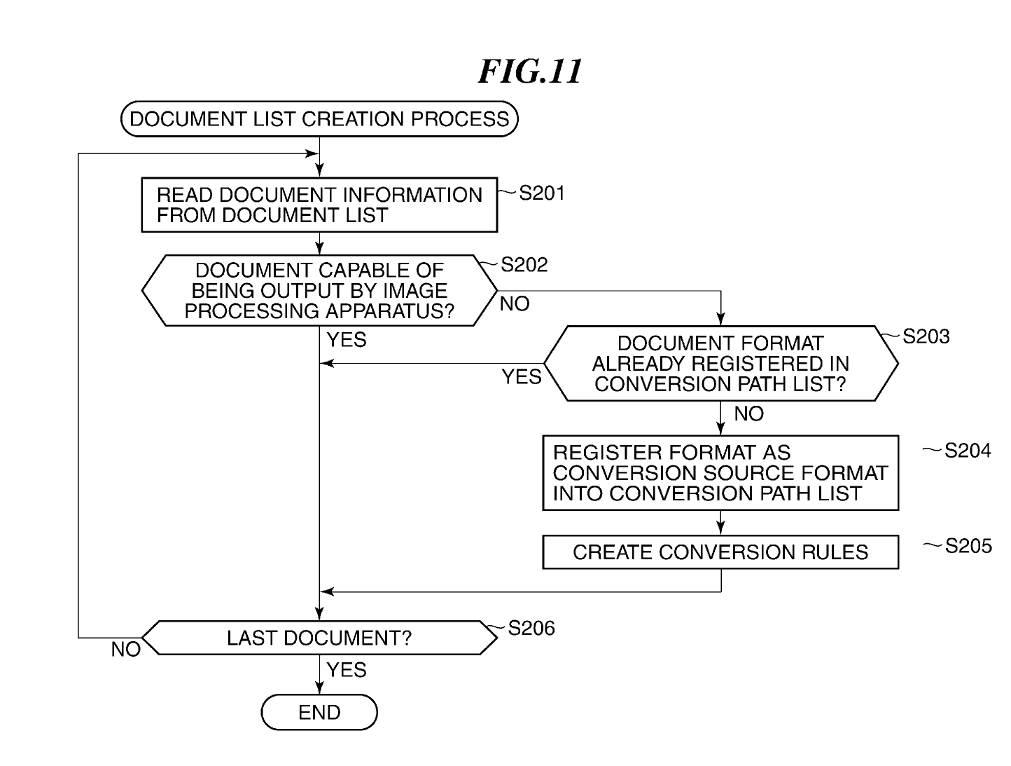

In the ROM 103, there are stored programs and parameters which are used to execute various processes including a document service reference process, document list creation process, document list display process, output process, format conversion process, conversion path update process, conversion path search process, and whole output process (see FIG. 3B). The details of these processes will be described later with reference to FIGS. 10 to 17.

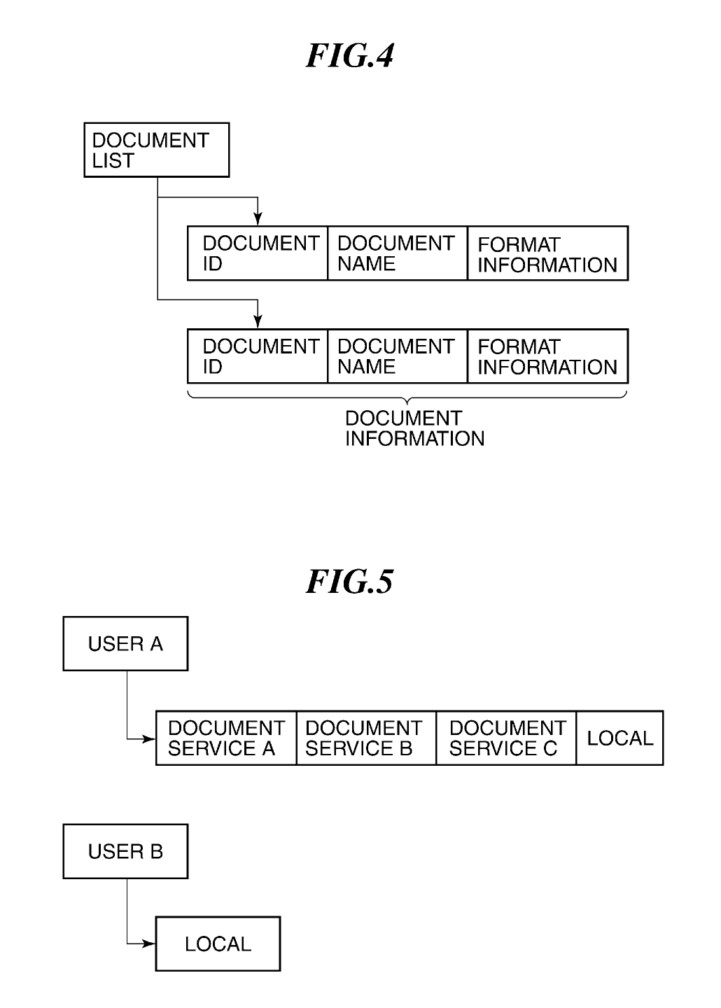

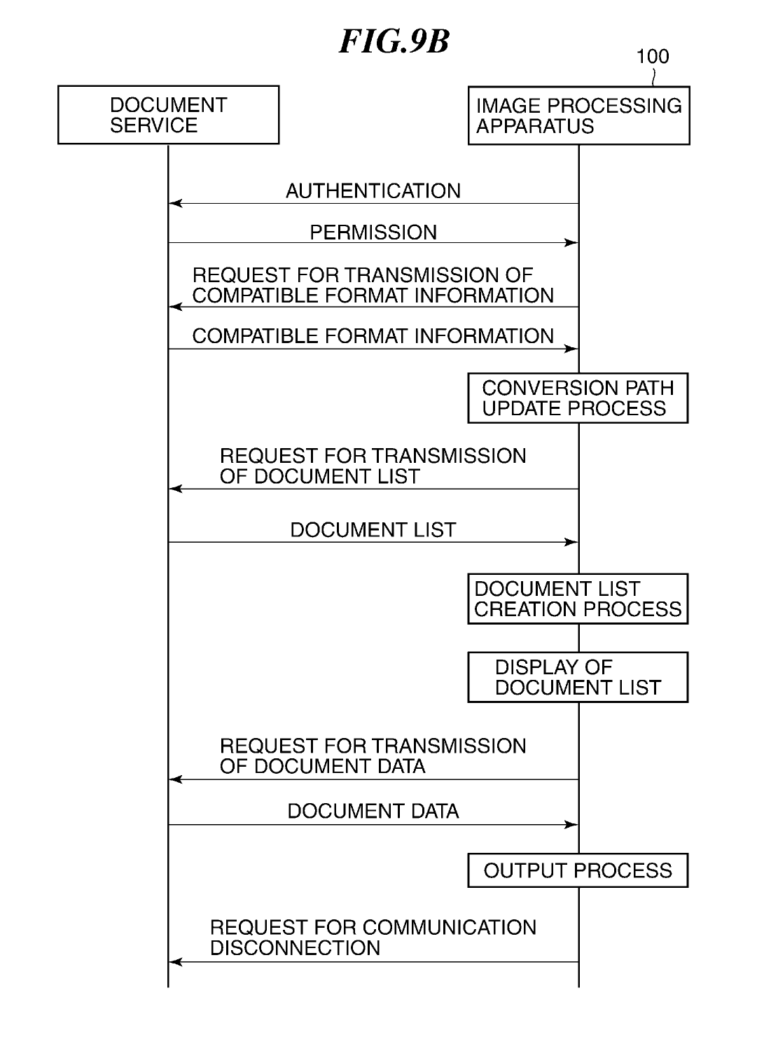

FIG. 4 schematically shows a part of the contents of a document list held in one of document services. As will be described later with reference to FIG. 9A or 9B, when any of document services is utilized by a user through the image processing apparatus 100, the image processing apparatus 100 acquires the document list held in the document service to be used. The document list includes pieces of document information. Each piece of the document information at least includes a document ID, document name, and document format information.

FIG. 5 schematically shows a part of the contents of the individual user's document service information stored in the RAM 102. In FIG. 5, the terms “Local” and “Document services A, B and C” respectively represent that a corresponding user is able to use the image processing apparatus 100 and the document services A, B and C. In the example shown in FIG. 5, a user A is able to use the document services A, B and C and the image processing apparatus 100, and a user B is able to use only the image processing apparatus 100.

FIG. 6 schematically shows the contents of the document service list stored in the RAM 102. In the document service list, pieces of information about document formats that can be used in the document services A, B and C (hereinafter, referred to as the compatible formats) are shown on a per document service basis. The information about compatible format(s) in each document service includes pieces of information that indicate input format, output format, and executable format conversion(s).

The information about executable format conversion(s) in each document service includes conversion source format information and one or more pieces of conversion destination format information. In the example of FIG. 6, it is indicated that format A can be converted into formats B and C in the document service A, format C can be converted into formats B and D in the document service B, and format D can be converted into format E in the document service C.

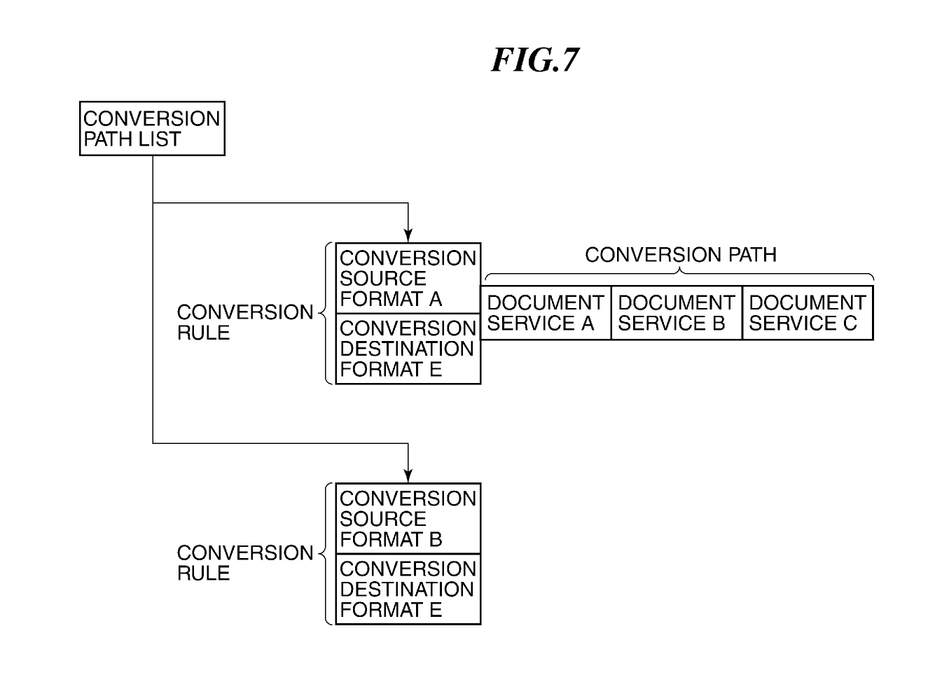

FIG. 7 schematically shows a part of the contents of the conversion path list, which is stored in the RAM 102. In the conversion path list, document format conversion paths are listed, which are used when document services are utilized. In the example of FIG. 7, it is indicated that a conversion path from the document service A to the document service B and to the document service C is used to perform conversion from conversion source format A to conversion destination format E. It is also indicated that there is no conversion path for conversion from format B to format E, so that the format B cannot be converted into the format E.

As previously described with reference to FIG. 6, pieces of information about format conversions executable in the document services A, B and C each include conversion source format information and conversion destination format information. As shown by way of example in FIG. 7, each of document format conversion paths in the conversion path list is represented by document service types. It should be noted that each document format conversion path corresponds to a combination of a conversion source format and a conversion destination format in format conversion that is executable in the document service concerned. For example, the conversion path from the document service A to the document service B and to the document service C, which is used to convert format A into format E as shown in FIG. 7, corresponds to a combination of conversion from format A to format C in the document service A, conversion from format C to format D in the document service B, and conversion from format D to format E in the document service C, which are shown in FIG. 6.

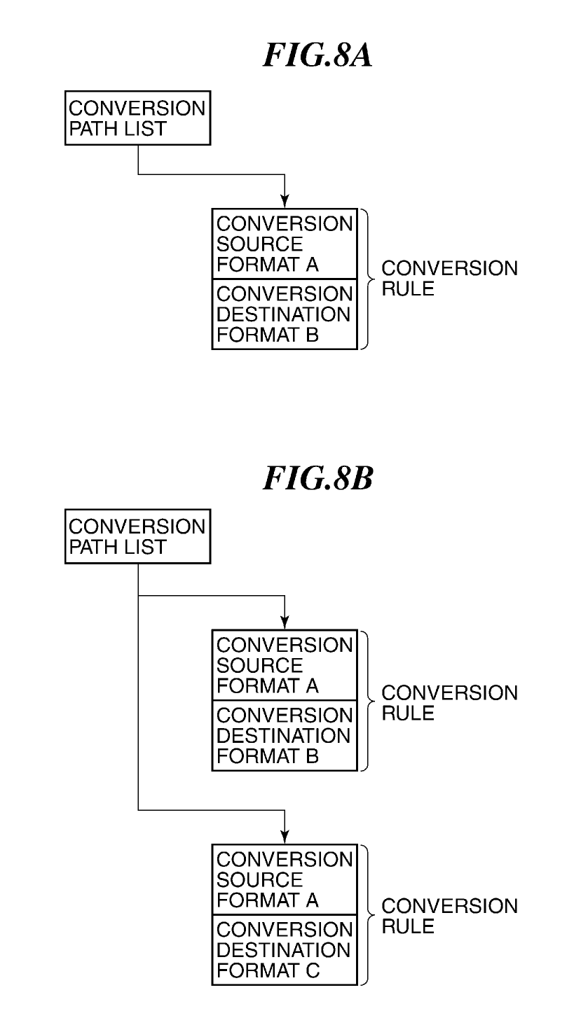

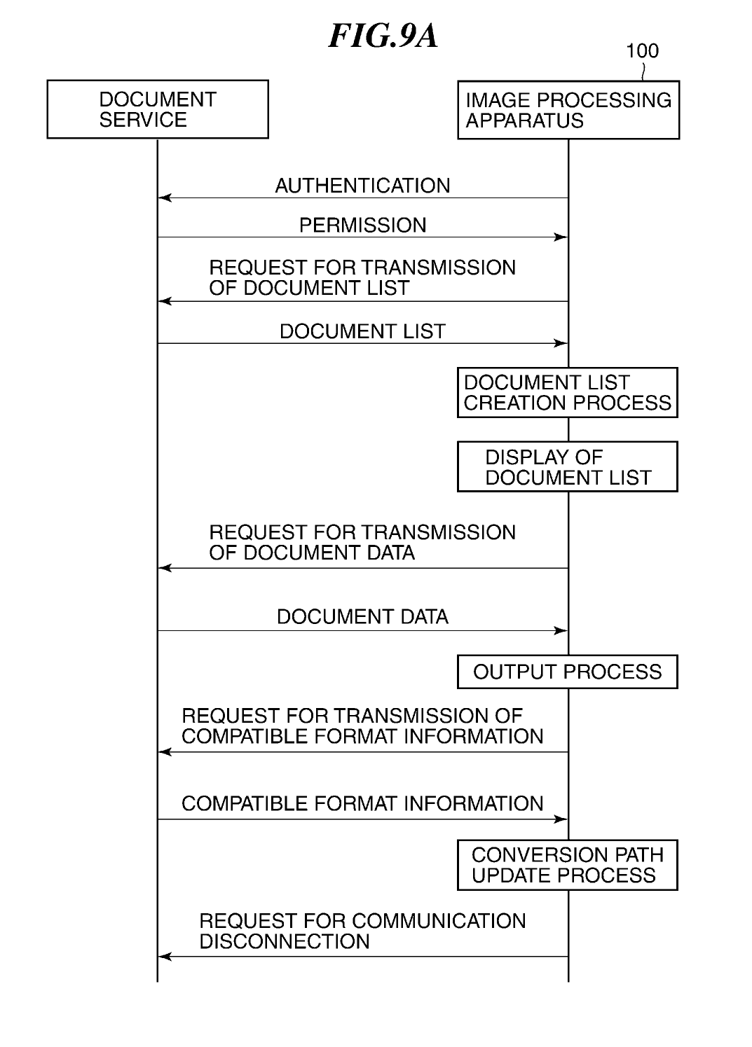

FIGS. 8A and 8B schematically show conversion rules defined in the conversion path list. When a request for format conversion from e.g., format A is generated, a conversion rule for conversion from format A to format B (FIG. 8A) is created, if the image processing apparatus 100 is compatible to format B, and conversion rules for conversions from format A to format B and from format A to format C (FIG. 8B) are created, if the image processing apparatus 100 is compatible to formats B and C.

In the following, information exchange executed between the image processing apparatus 100 and any of the document services A, B and C when the image processing apparatus 100 acquires document data from the document service and outputs the acquired data will be described in comparison with a conventional method.

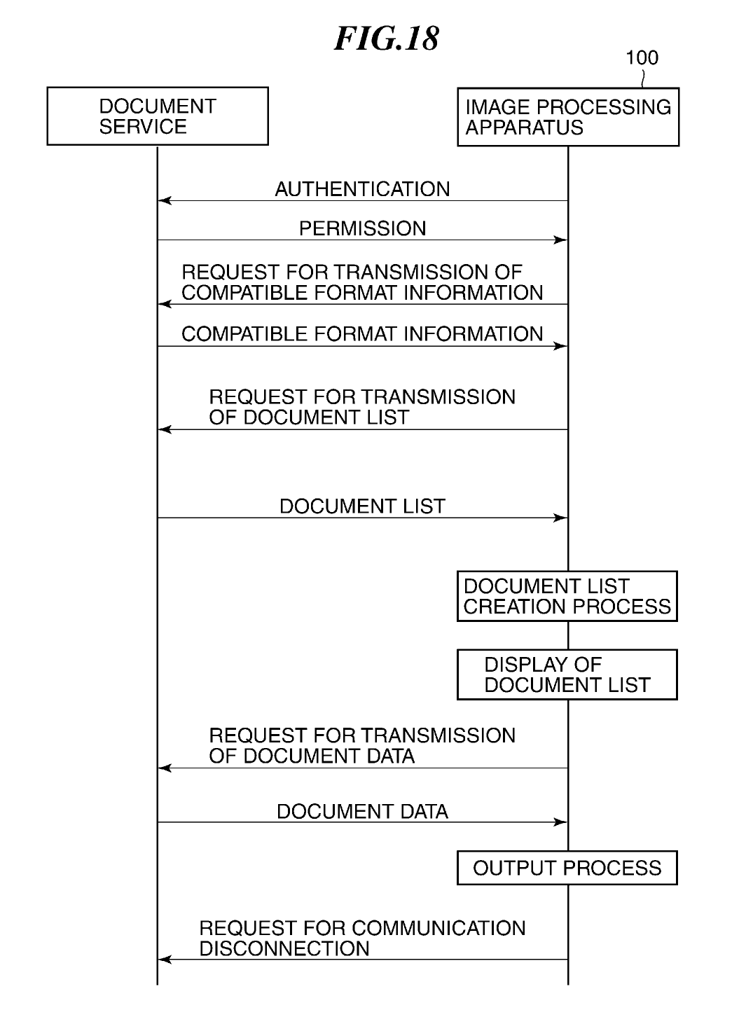

FIG. 18 shows conventional information exchange executed between any of the document services A, B, and C and the image processing apparatus 100.

It is assumed here that user registration for the document service has been made in advance and account information necessary to utilize the document service is stored in the RAM 102 of the image processing apparatus 100. When an instruction to access the document service is input by the user through the operation unit 105, the image processing apparatus 100 (more specifically, the CPU 101) reads the account information (account and password) necessary to utilize the document service from the RAM 102, and communicates with the document service to perform authentication necessary to utilize the document service from the image processing apparatus 100.

If the authentication is succeeded and the document service allows the use of the document service, the image processing apparatus 100 sends a request for transmission of pieces of compatible format information to the document service. When the pieces of compatible format information are sent back from the document service, the image processing apparatus 100 requests the document service to transmit a document list. The document service sends back the document list held in the document service to the image processing apparatus 100.

Based on the document list acquired from the document service, the image processing apparatus 100 performs a document list creation process and displays a created document list on the operation unit 105. From among document data in the document list, the user is able to select document data to be acquired from the document service. The image processing apparatus 100 requests the document service to transmit the document data selected by the user. The document service transmits the requested document data to the image processing apparatus 100. The image processing apparatus 100 performs an output process such as printing the document acquired from the document service, and transmits a request for communication disconnection to the document service when the user logs off from the image processing apparatus 100.

Next, a description will be given of a sequence of information exchange executed in this embodiment between any of the document services A, B, and C and the image processing apparatus 100. FIG. 9A shows in sequence diagram the information exchange executed between the document service and the image processing apparatus 100.

In the information exchange sequence shown in FIG. 18, the image processing apparatus 100 requests the document service to transmit pieces of compatible format information immediately after the authentication is succeeded. In comparison therewith, the information exchange sequence shown in FIG. 9A is different in that the information processing apparatus 100 requests the document service to transmit a document list immediately after the authentication is succeeded, requests the document service to transmit pieces of compatible format information after completion of an output process, and performs a conversion path update process after acquisition of the pieces of compatible format information.

More specifically, in the information exchange sequence of FIG. 9A, when any of compatible formats in the document service is updated, a corresponding format conversion path in the document list is updated. Since it takes much time to update the document list, the document list is acquired in the information exchange sequence of FIG. 9A prior to the acquisition of pieces of information about compatible formats in the document service.

In a case where the user utilizes any of the document services for the first time, information exchange sequence shown in FIG. 9B is used. The information exchange sequence of FIG. 9B is basically the same as that of FIG. 9A, but differs from the sequence of FIG. 9A in that pieces of compatible format information are acquired immediately after the authentication is succeeded, as with the information exchange sequence of FIG. 18.

This is because there are no pieces of document format information necessary for creation of conversion paths for the document service accessed for the first time although conversion paths for the already accessed document services have been created based on pieces of compatible format information that were already acquired. For this reason, in the information exchange sequence of FIG. 9B, pieces of information about compatible formats in the document service are first acquired, and based on the acquired compatible format information, conversion paths are created for use by the image processing apparatus 100 to convert a document of non-compatible format into compatible format.

In the following, the information exchange sequences of FIGS. 9A and 9B will be further described with reference to FIG. 10. FIG. 10 shows in flowchart the procedures of a process performed by the image processing apparatus 100 in the information exchange sequences of FIGS. 9A and 9B.

When an instruction to access any of the document services A, B, and C is input by the user through the operation unit 105, the image processing apparatus 100 (more specifically, the CPU 101) reads account information necessary to utilize the document service from the RAM 102, and communicates with the document service through the network 300 to perform authentication necessary to utilize the document service (step S101).

If the authentication is succeeded, it is determined whether the present access is a first access (i.e., an access performed for the first time) to the document service from when the user subscribed (contracted) to the document service (step S102). For example, whether or not the present access is the first access is determined with reference to a history of access to the document service, which is stored in the RAM 102. If the answer to step S102 is NO, the process proceeds to step S104.

If it is determined that the present access is the first access (i.e., if YES to S102), a conversion path update process is performed (step S103), and a document list is acquired (step S104). Then, a document list creation process and a document list display process are sequentially performed (steps S105 and S106). The details of the processes will be described later.

In the document list display process in step S106, a document list is displayed on the user interface (operation unit 105) of the image processing apparatus 100. When a document to be output is selected by the user from the document list, an output process is performed, the details of which will be described later (step S107).

Next, it is determined whether the conversion path update process in step S103 has been performed (step S108). If the answer to step S108 is YES, the process of FIG. 10 is completed. If the conversion path update process in step S103 has not been performed (i.e., if NO to S108), a conversion path update process is performed, the details of which will be described later (step S109), whereupon the process of FIG. 10 is completed.

FIG. 11 shows in flowchart the procedures of the document list creation process performed in step S105 of FIG. 10. A program, parameters, and the like, which are necessary for execution of the document list creation process, are stored in the ROM 103 (see FIG. 3). The document list creation process is performed by the CPU 101 by developing the program in the RAM 102 and executing the developed program. This also applies to the document list display process, output process, format conversion process, conversion path update process, conversion path search process, and whole output process.

In the document list creation process, a first piece of document information is read from the document list acquired in step S104 of FIG. 10 (step S201). Based on format information (see FIG. 4) contained in the read document information, it is determined whether a document format corresponding to the format information is supported by the image processing apparatus 100, thereby determining whether or not a document can be output (printed) in the document format by the image processing apparatus 100 (step S202).

If the image processing apparatus 100 cannot output the document (i.e., if NO to S202), it is determined whether the document format has been registered as a conversion source format in the conversion path list (step S203). If the document format has not been registered (i.e., if NO to S203), the format is registered as a conversion source format into the conversion path list (step S204), and one or more conversion rules (such as those shown by way of example in FIGS. 8A and 8B) are created, each of which is represented by a combination of the registered conversion source format and one or more conversion destination formats that can be output by the image processing apparatus 100 (step S205).

If the image processing apparatus 100 can output the document (i.e., if YES to S202) or if the document format has already been registered in the conversion path list (i.e., if YES to S203) or if step S205 has been completed, the process proceeds to step S206 where it is determined whether the document information read in step S201 indicates the last document in the document list. If the document information indicates the last document (i.e., if YES to S206), the present process is completed and proceeds to step S106 of FIG. 10. On the other hand, if the document information does not indicate the last document (i.e., if NO to S206), the process returns to step S201 where the next piece of document information is read from the document list.

With the above-described document list creation process, the document list is created that includes document names, pieces of information indicating whether documents can be output by the image processing apparatus 100, and format conversion paths for documents that can be output by the image processing apparatus 100. The created document list is stored into the RAM 102 or into a storage section of the output unit 104. Further, conversion rules are created that are used to convert document formats that cannot directly be output by the image processing apparatus 100 into document formats that can be output by the image processing apparatus 100.

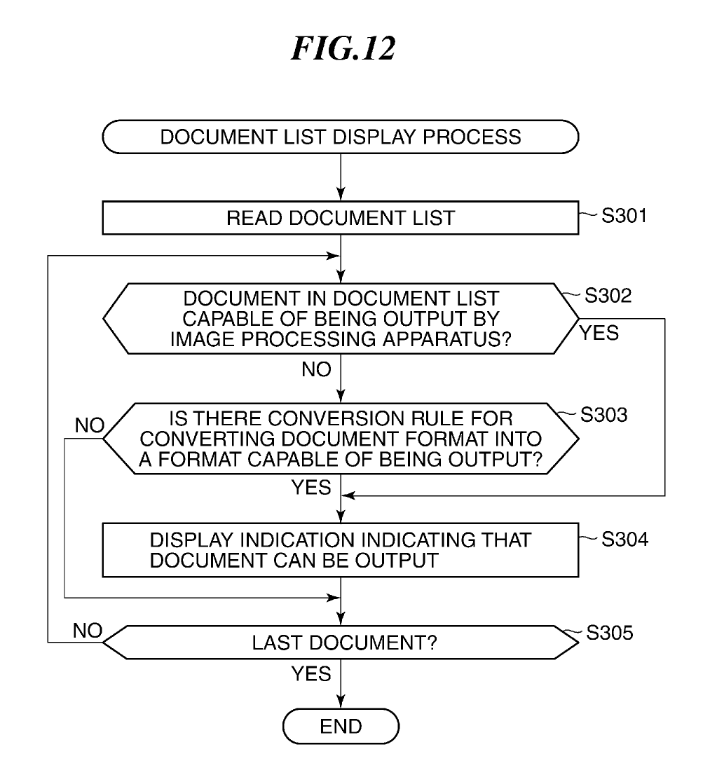

FIG. 12 shows in flowchart the procedures of the document list display process performed in step S106 of FIG. 10.

In the document list display process, the document list held in the RAM 102 or in the storage section of the output unit 104 is read (step S301), and it is confirmed whether a first one of documents in the read document list can directly be output by the image processing apparatus 100 (step S302).

If the document cannot directly be output by the image processing apparatus 100 (i.e., if NO to S302), it is determined whether there is a conversion rule for converting the format of the document (conversion source format) into a format that can be output by the image processing apparatus 100, while referring to the conversion path list (step S303).

If there is a conversion rule for converting the document format into a format that can be output by the image processing apparatus 100 (i.e., if YES to S303), an indication to the effect that the document can be output is displayed, together with a document name, on the user interface of the image processing apparatus 100, and a flag for the document is set to be ON (step S304). If step S304 is completed or if there is no conversion rule for converting the document format into a format that can be output (i.e., if NO to S303), the process proceeds to step S305 where it is determined whether the document read in step S301 is the last document in the document list. If the document is the last document (i.e., if YES to S305), the present process is completed and proceeds to step S107 of FIG. 10. If the document is not the last document (i.e., if NO to S305), the process returns to step S302 in which it is confirmed whether the next document in the document list can directly be output by the image processing apparatus 100.

With the above-described document list display process, whether or not each of all the documents contained in the document list can be output by the image processing apparatus 100 is displayed on the user interface, together with the document name.

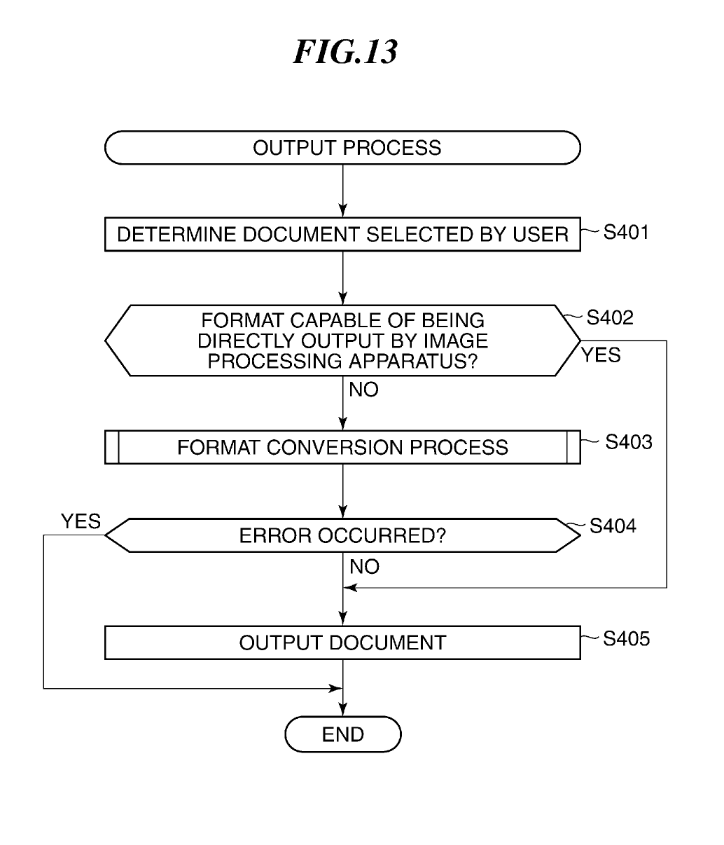

FIG. 13 shows in flowchart the procedures of the output process performed in step S107 of FIG. 10.

In the output process, a document is determined that is selected by the user from among documents which are displayed on the user interface as capable of being output in the document list display process (step S401). Then, it is confirmed whether the format of the determined document is any of formats that can directly be output by the image processing apparatus 100 (step S402).

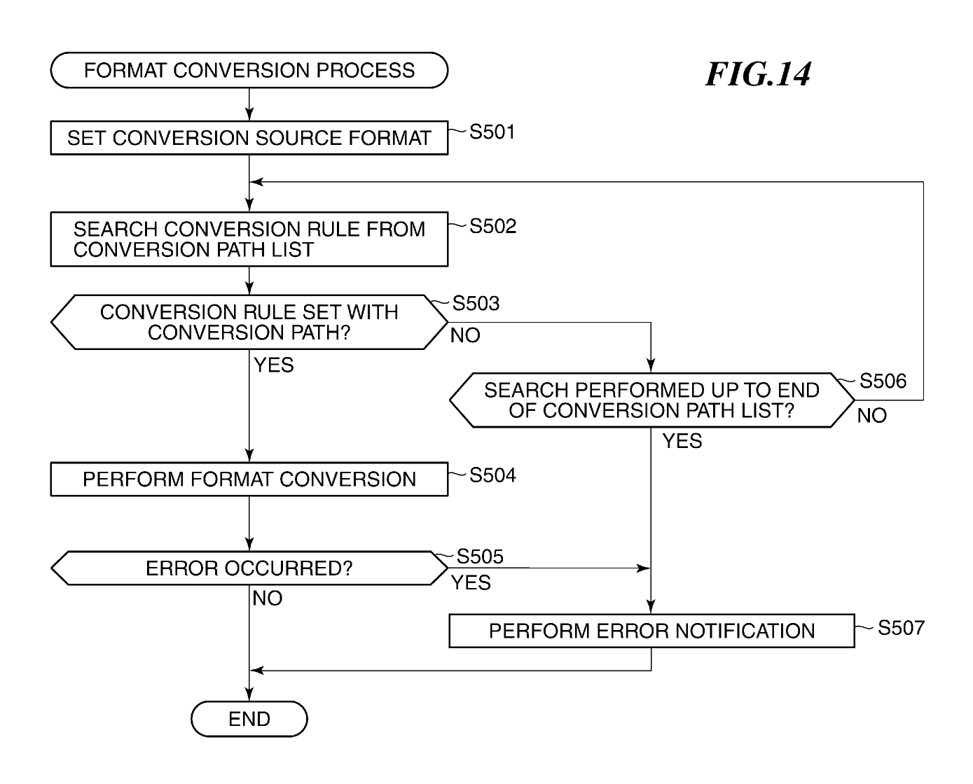

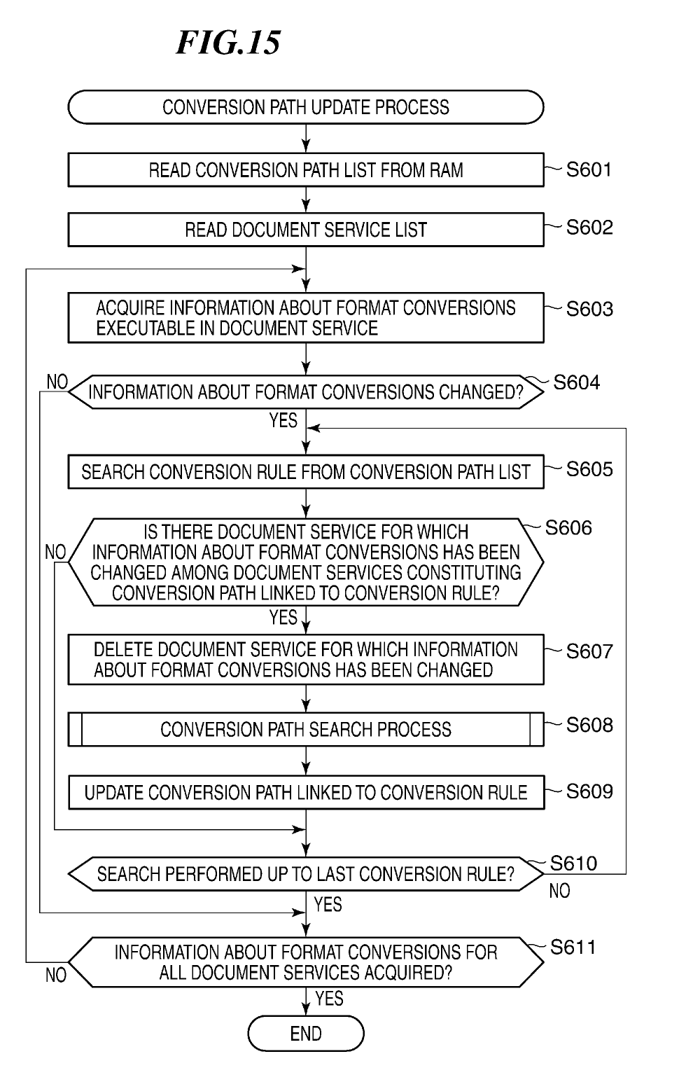

If the format of the document is a format that can directly be output by the image processing apparatus 100 (i.e., if YES to S402), document data for the document is acquired from the document service and the acquired document is output (step S405). If the format of the document is a format that cannot directly be output by the image processing apparatus 100 (i.e., if NO to S402), the document format conversion process is performed (step S403), the details of which will be described with reference to FIG. 14. Next, it is determined whether any error has occurred in the format conversion process (step S404).

If an error has occurred in the format conversion process (i.e., if YES to S404), the present process is completed. On the other hand, if the format conversion process has normally been completed (i.e., if NO to S404), the document is output in the format after conversion (step S405).

With the above-described output process, the document selected by the user is output by the image processing apparatus 100.

FIG. 14 shows in flowchart the procedures of the format conversion process performed in step S403 of FIG. 13.

In the format conversion process, the format of the document, which is determined as being selected by the user in step S401 of FIG. 13, is set as a conversion source format (step S501), and a conversion rule including the conversion source format set in step S501 and a conversion destination format compatible with the image processing apparatus 100 is searched from the conversion path list (step S502).

If such a conversion rule is found from the conversion path list, it is determined whether the conversion rule is set with a conversion path (step S503). If the conversion rule is set with a conversion path (i.e., if YES to S503), format conversion is performed in accordance with the conversion path (step S504). In the format conversion of step S504, a series of processing are performed. For example, document data is uploaded in the conversion source format (see FIG. 6) set in a first one of document services constituting the conversion path (see FIG. 7), and downloaded or exported in the conversion destination format (see FIG. 6) set in the document service. Then, similar processing are sequentially performed based on conversion source formats and conversion destination formats, which are set in subsequent ones of the document services constituting the conversion path, whereby document data that can be output by the image processing apparatus 100 is finally acquired.

Next, whether or not any error has occurred in the format conversion in step S504 is determined (step S505). If no error has occurred (i.e., if NO to S505), the present process is completed. If any error has occurred (i.e., if YES to S505), an error notification is performed (step S507), whereupon the present process is completed.

If no conversion rule is found from the conversion path list or if the conversion rule found from the conversion path list is set with no conversion path (i.e., if NO to S503), whether or not the search is performed up to the end of the conversion path list is determined (step S506). If the search is not performed up to the end of the conversion path list (i.e., if NO to S506), the process returns to step S502. If the search is performed up to the end of the conversion path list (i.e., if YES to S506), the process proceeds to step S507 where an error notification is performed, whereupon the present process is completed.

With the above-described format conversion process, even if a document acquired from a particular document service cannot directly be output by the image processing apparatus 100, it becomes possible to output the document by the image processing apparatus 100 by converting the format of the document according to a conversion path represented by a combination of plural document services.

FIG. 15 shows in flowchart the procedures of the conversion path update process performed in step S109 of FIG. 10.

In the conversion path update process, the conversion path list stored in the RAM 102 is read (step S601). It should be noted that the conversion path update process performed in step S103 in FIG. 10 is the same as the conversion path update process performed in step S109 except that an empty conversion path list is created and read instead of reading the conversion path list stored in the RAM 102.

Next, the document service list is read (step S602), and pieces of information about format conversions that can be executed in a first one of document services indicated in the document service list are acquired (step S603). More specifically, inquiry is made to a document service server that provides the document service, and pieces of information about format conversions that can be executed in the document service are acquired from the document service server.

Next, the pieces of information about format conversions executable in the document service which are acquired from the document service server in step S603 are compared with the pieces of information about format conversions executable in the corresponding one of the document services indicated in the document service list read from the RAM 102 in step S601, thereby determining whether or not the pieces of information about format conversions have been changed (step S604). If the pieces of information about format conversions have not been changed (i.e., if NO to S604), the process proceeds to step S611. If the pieces of information about format conversions have been changed (i.e., if YES to S604), a first one of conversion rules is searched from the conversion path list (see FIG. 7) (step S605).

Then, it is determined whether or not a document service for which pieces of information about format conversions have been changed is present among document services that constitute a conversion path linked to the conversion rule (step S606). If the answer to step S606 is NO, the process proceeds to step S610.

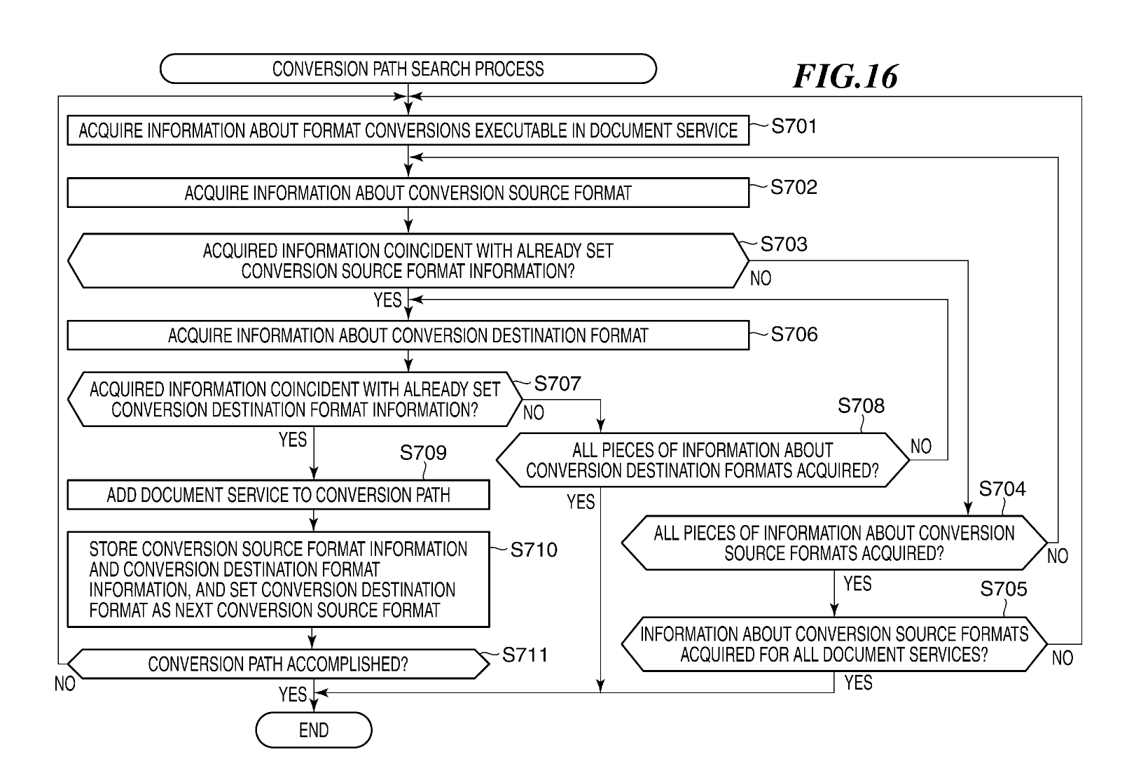

If the answer to S606 is YES, the document service for which pieces of information about format conversions have been changed (among the document services that constitute the conversion path linked to the conversion rule) is deleted (step S607). Then, to again create the conversion rule, a conversion path search process is performed on the conversion rule for which the document service is deleted (step S608). The details of the conversion path search process will be described later with reference to FIG. 16. Next, based on a conversion path found in the conversion path search process of step S608, the conversion path linked to the conversion rule is updated (i.e., again created) and stored in the RAM 102 (step S609).

Next, whether or not the search is performed on all the conversion rules indicated in the conversion path list is determined (step S610). If the answer to step S610 is NO, the process returns to step S605 in which the next conversion rule is searched from the conversion path list. If the answer to step S610 is YES, the process proceeds to step S611.

In step S611, whether or not pieces of information about format conversions have been acquired from all the document service servers is determined. If the answer to step S611 is NO, the process returns to S603 in which pieces of information about format conversions executable in the next document service indicated in the document service list are acquired from the server that provides the next document service. If the answer to step S611 is YES, the present process is completed.

With the above-described conversion path update process, if any of pieces of information about format conversions executable in document services is updated, document services constituting a corresponding conversion path are updated, thereby updating the conversion path list.

FIG. 16 shows in flowchart the procedures of the conversion path search process performed in step S608 of FIG. 15.

In the conversion path search process, individual user's document service information is read, and a first one of document services represented by the document service information is accessed to acquire therefrom pieces of information about format conversions that can be executed in the document service (step S701). Next, information about a first one of conversion source formats is acquired from the acquired pieces of information about format conversions (step S702).

Next, whether or not the conversion source format set at start of the conversion path search process coincides with the conversion source format represented by the information acquired in step S702 is determined (step S703). If both the formats coincide with each other (i.e., if YES to S703), the process proceeds to step S706. If these formats do not coincide with each other (i.e., if NO to S703), it is determined whether all the pieces of information about conversion source formats associated with format conversions executable in the document service accessed in step S702 have been acquired (step S704).

If all the pieces of information about conversion source formats have not been acquired (i.e., if NO to S704), the process returns to step S702 in which the next conversion source format is acquired from the pieces of information about format conversions acquired in step S701. If all the pieces of information about conversion source formats have been acquired (i.e., if YES to S704), the process proceeds to step S705 in which it is determined whether pieces of information about conversion source formats associated with format conversions that can be executed in each document service have been acquired for all the document services represented by the document service information.

If pieces of information about conversion source formats for all the document services have not been acquired (i.e., if NO to S705), the process turns to step S701 in which pieces of information about format conversions that can be executed in the next document service are acquired. If pieces of information about conversion source formats for all the document services have been acquired (i.e., if YES to S705), the present process is completed.

In step S706, information about a first one of conversion destination formats associated with the document service is acquired, and it is determined whether the conversion destination format represented by the acquired information coincides with the conversion destination format set at start of the conversion path search process (step S707). If these conversion destination formats are coincident with each other (i.e., if YES to S707), the process proceeds to step S709. If the conversion destination formats are not coincident with each other (i.e., if NO to S707), it is determined whether all the pieces of information about conversion destination formats associated with the document service have been acquired (step S708).

If all the pieces of information about conversion destination formats have not been acquired (i.e., if NO to S708), the process returns to step S706 in which information about the next conversion destination format is acquired. If all the pieces of information about conversion destination formats have been acquired (i.e., if YES to S708), the present process is completed.

In step S709, the information about the conversion source format acquired in step S702 and the information about the conversion destination format acquired in step S706, which are associated with the document service, are stored into the RAM 102. Then, the document service is added to the conversion path associated with the conversion rule subjected to the conversion path search process. Next, the conversion destination format stored in the RAM 102 in step S709 is set as the next conversion source format in the conversion path (step S710).

Next, it is determined whether the conversion path to the conversion destination format set at the start of the conversion path search process is accomplished (step S711). If the conversion path is accomplished (i.e., if YES to S711), the present process is completed. If the conversion path is not accomplished (i.e., if NO to S711), the process returns to step S701.

With the above-described conversion path search process, it is possible to attain, by combining format conversions executable by plural document services, a conversion path for converting a document format that cannot directly be output by the image processing apparatus 100 into a format that can be output by the apparatus 100.

As described above, according to the process procedures of FIG. 10 performed by the image processing apparatus 100, document data and information about format thereof can be acquired when any of document services is accessed by the user, whereby document data processing can be carried out without applying a large load to the document server and to the image processing apparatus 100 and a user interface excellent in usability can be provided.

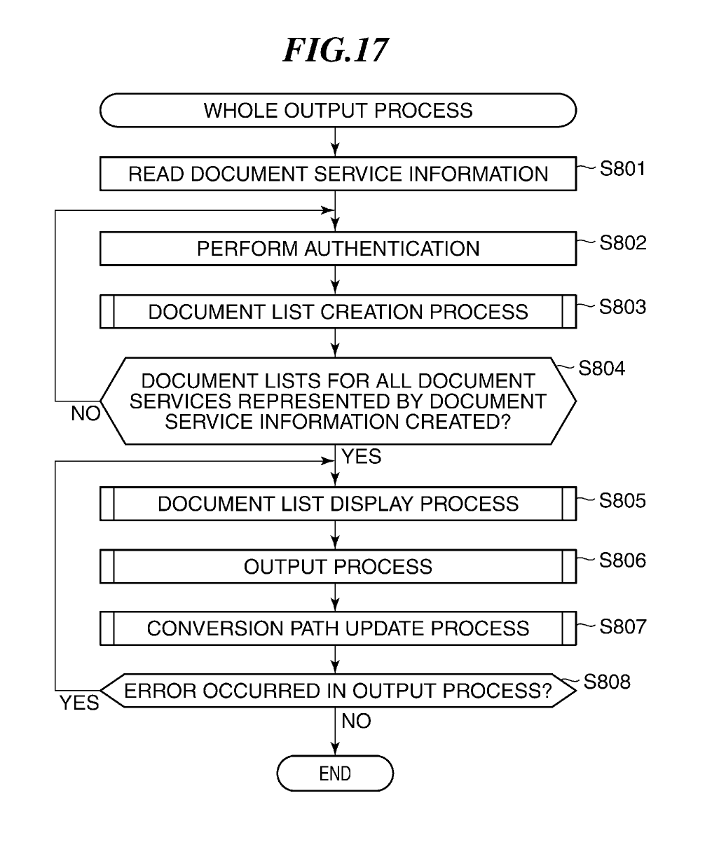

FIG. 17 shows in flowchart a whole output process performed by the image processing apparatus 100 and comprised of process procedures, which are different from the process procedures shown in FIG. 10.

When an instruction to access any of document services is input by the user through the operation unit 105, the image processing apparatus (more specifically, the CPU 101) reads document service information (see FIG. 5) that indicates document services that can be utilized by the user (step S801), performs authentication about use of a first one of the document services represented by the document service information based on user account information or the like (step S802). If the authentication has succeeded, the document list creation process already described with reference to FIG. 11 is performed, whereby the document list (see FIG. 4) is created (step S803). It should be noted that if the document service information indicates that the user can utilize the image processing apparatus 100, the document list for the image processing apparatus 100 is created in the document list creation process in step S803.

Next, it is determined whether document lists for all the document services represented by the document service information have been created (step S804). If the document lists for all the document services have not been created (i.e., if NO to S804), the process returns to step S802 in which authentication about use of the next document service is performed.

If the documents lists for all the document services have been created (i.e., if YES to S804), the process proceeds to step S805 in which a document list display process is performed by using the document lists created in step S803, whereby the document list indicating all the documents that can be used by the user is displayed on the user interface of the image processing apparatus 100, together with indications indicating that corresponding documents (if capable of being output by the image processing apparatus 100) can be printed. When a desired document is selected from the document list by the user, the output process already described with reference to FIGS. 13 and 14 is performed, and the document selected by the user is output by the image processing apparatus 100 (step S806).

Next, the conversion path update process already described with reference to FIGS. 15 and 16 is performed, and the conversion path list is updated, if any of pieces of information about format conversions executable in document services is updated (step S807). Then, whether or not an error has occurred in the output process is confirmed (step S808). If no error has occurred (i.e., if NO to S808), the present process is completed. If an error has occurred (i.e., if YES to S808), the process returns to step S805.

In the process procedures of FIG. 17, the conversion path update process is performed after the output process in order to improve the efficiency of data processing, but this is not limitative. In a case that the updating of document service information is performed with priority, the conversion path update process can be performed before the document list display process. Further, it is possible to identify documents that can directly be printed by the image processing apparatus 100 and documents that become capable of being printed by the image processing apparatus 100 by using a combination of document services and to display the identified documents.

With the above-described process procedures, when any of plural document services to which the user subscribe is utilized by the user through the image processing apparatus 100, the following advantages can be achieved. Specifically, the user is able to use the printing function of the image processing apparatus 100 without paying attention to the document format to be used in the document service. Since a document service which the image processing apparatus 100 accesses is automatically switched, the user can utilize the document service to which the user is accessing and the image processing apparatus 100 at the maximum performance, while unconsciously using plural document services.

### Other Embodiments

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2010-248641, filed Nov. 5, 2010, which is hereby incorporated by reference herein in its entirety.

What is claimed is:

1. An image processing apparatus capable of accessing plural document services through a network, comprising:
a storage unit configured to store pieces of information about document format conversions executable by respective ones of the plural document services;
a format acquisition unit configured, when a document service usable by a user among the plural document services is accessed, to acquire information about document format conversion from the accessed document service;
an update unit configured to update the pieces of information about document format conversions stored in said storage unit based on the information about document format conversion acquired by said format acquisition unit;
a data acquisition unit configured to acquire document data held in the accessed document service from the accessed document service;
an output unit configured to output the document data acquired by said data acquisition unit; and
a control unit configured to control said format acquisition unit and said data acquisition unit such that said format acquisition unit acquires the information about document format conversion after said data acquisition unit has acquired the document data.

2. An image processing apparatus capable of accessing plural document services through a network, comprising:
a storage unit configured to store pieces of information about document format conversions executable by respective ones of the plural document services;
a format acquisition unit configured, when a document service usable by a user among the plural document services is accessed, to acquire information about document format conversion from the accessed document service;
an update unit configured to update the pieces of information about document format conversions stored in said storage unit based on the information about document format conversion acquired by said format acquisition unit;
a data acquisition unit configured to acquire document data held in the accessed document service from the accessed document service; and
a control unit configured to control whether said format acquisition unit should acquire the information about document format conversion before or after the document data is acquired by said data acquisition unit.

3. An image processing apparatus capable of accessing plural document services through a network, comprising:
a storage unit configured to store pieces of information about document format conversions executable by respective ones of the plural document services;
a document information acquisition unit configured to acquire, from any of the plural document services that is accessed by the image processing apparatus, pieces of information about plural documents held in the accessed document service;
a display unit configured to display the pieces of information about plural documents acquired by said document information acquisition unit;
an identification unit configured to identify, based on information contained in the pieces of information about plural documents acquired by said document acquisition unit and representing formats of the plural documents and the pieces of information about document format conversions executable by the plural document services stored in said storage unit, at least one document that becomes capable of being processed by the image processing apparatus after the document format thereof is converted by corresponding ones of the plural document services; and
a control unit configured to cause said display unit to distinguishably display, among documents represented by the pieces of information about plural documents acquired by said document information acquisition unit, at least one document of the format that can be processed by the image processing apparatus and the at least one document identified by said identification unit, as documents that can be output by the image processing apparatus.

4. A control method for an image processing apparatus capable of accessing plural document services through a network, comprising:
a storage step of storing pieces of information about document format conversions executable by respective ones of the plural document services into a storage unit;
a format acquisition step of acquiring, when a document service usable by a user among the plural document services is accessed, information about document format conversion from the accessed document service;
an update step of updating the pieces of information about document format conversions stored into the storage unit in said storage step based on the information about document format conversion acquired in said format acquisition step;
a data acquisition step of acquiring document data in the accessed document service from the accessed document service; and
a control step of controlling executions of said format acquisition step and said data acquisition step such that the information about document format conversion is acquired in said format acquisition step after the document data has been acquired in said data acquisition step.

5. A control method for an image processing apparatus capable of accessing plural document services through a network, comprising:
a storage step of storing pieces of information about document format conversions executable by respective ones of the plural document services into a storage unit;
a format acquisition step of acquiring, when a document service usable by a user among the plural document services is accessed, information about document format conversion from the accessed document service;
an update step of updating the pieces of information about document format conversions stored into the storage unit in said storage step based on the information about document format conversion acquired in said format acquisition step;
a data acquisition step of acquiring document data held in the accessed document service from the accessed document service; and
a control step of controlling whether the information about document format conversion should be acquired in said format acquisition step before or after the document data is acquired in said data acquisition step.

6. A control method for an image processing apparatus capable of accessing plural document services through a network, comprising:
a storage step of storing pieces of information about document format conversions executable by respective ones of the plural document services into a storage unit;
a document information acquisition step of acquiring, from any of the plural document services that is accessed by the image processing apparatus, pieces of information about plural documents held in the accessed document service;
a display step of displaying the pieces of information about plural documents acquired in said document information acquisition step;
an identification step of identifying, based on information contained in the pieces of information about plural documents acquired in said document acquisition step and representing formats of the plural documents and the pieces of information about document format conversions executable by the plural document services stored in the storage unit in said storage step, at least one document that becomes capable of being processed by the image processing apparatus after the document format thereof is converted by corresponding ones of the plural document services; and
a control step of causing, among documents represented by the pieces of information about plural documents acquired in said document information acquisition step, at least one document of the format that can be processed by the image processing apparatus and the at least one document identified in said identification step to be distinguishably displayed in said display step, as documents that can be output by the image processing apparatus.
